(19) United States
(12) Patent Application Publication
(10) Pub. No.: US 2021/0233425 A1
(43) Pub. Date: Jul. 29, 2021

(54) THERMOCHROMIC AIMING, EDUCATIONAL, AND TRAINING DEVICE FOR SINKS, BATHTUBS, AND URINALS

(71) Applicant: AIMODRI, LLC, Boca Raton, FL (US)

(72) Inventors: Calvin Dan Longton, Naples, FL (US); Wallace A. Longton, Boca Raton, FL (US)

(73) Assignee: AIMODRI, LLC, Boca Raton, FL (US)

(21) Appl. No.: 17/156,951

(22) Filed: Jan. 25, 2021

Related U.S. Application Data
(60) Provisional application No. 62/965,456, filed on Jan. 24, 2020.
(60) Provisional application No. 63/014,961, filed on Apr. 24, 2020.

(51) Int. Cl. G09B 19/00; G02F 1/01

(52) U.S. Cl. CPC G09B 19/0076; E03D 13/005; G02F 1/0147

(57) ABSTRACT

A thermochromic device includes a base including a surface and an image provided on the surface of the base. A layer of thermochromic material covers at least a portion of the image provided on the surface of the base. When a temperature of the layer of thermochromic material changes across a predetermined magnitude, a visual characteristic of the layer of thermochromic material changes from a first condition, such as being opaque, to a second condition, such as being transparent or translucent.

### CROSS-REFERENCE TO RELATED APPLICATIONS

This application claims the benefit of U.S. Provisional Application No. 62/965,456, filed Jan. 24, 2020 and U.S. Provisional Application No. 63/014,961, filed Apr. 24, 2020. The disclosures of both of these applications are incorporated herein by reference.

### BACKGROUND OF THE INVENTION

While many people did not realize the importance of frequently washing their hands until recently with the COVID-19 virus pandemic, a significant number of people still do not appreciate that to properly wash the hands requires at least twenty seconds under running water using soap in the sink. Many people, particularly children, tend to wash and rinse their hands too quickly, which does not properly cleanse the hands and remove all bacteria and virus from the skin surface. Accordingly, there is a need for a device that encourages people, particularly children, to wash their hands under running water in the sink for at least twenty seconds.

Public and other restrooms, particularly in busy locations (such as airports, sports event venues, stadiums, arenas, and the like), can be difficult to keep clean. In particular, most public men's bathrooms have at least one or more urinals that are located along one or more walls. Inevitably, a significant amount of urine ends up on the floor of the bathroom due to poor aiming of the stream of urine by people using the men's room. This creates a public health issue that can be of significant concern. Moreover, it is simply unpleasant to use public restrooms that are not kept sanitary.

In the past, others have proposed various target devices, such as a bee, that is placed in the urinal, usually on the rubber pad that covers the drain holes in the urinal. The purpose of the target device is to capture the attention of the person using the urinal and to encourage the user to direct the stream of urine flow toward the target (which is usually centered within the bottom of the urinal) so that the stream of flow does not move towards the outer edges of the urinal. While these target devices can be effective, they often do not fully capture the attention of persons using the urinal. If the target device was made to be more of an entertainment feature or to provide visible images such as advertisements, entertainment, pictures and/or caricatures, then they would attract the attention of the user and help to keep the user's eyes focused on the target throughout the entire process of using the urinal.

### SUMMARY OF THE INVENTION

This invention relates in general to a device that can be placed within a urinal, sink, or other water basin or area in which water is used. More particularly, this invention relates to a thermochromic device that changes a visual characteristic in response to change in temperature. The thermochromic device includes a base including a surface and an image provided on the surface of the base. A layer of thermochromic material covers at least a portion of the image provided on the surface of the base. When a temperature of the layer of thermochromic material changes across a predetermined magnitude, a visual characteristic of the layer of thermochromic material changes from a first condition, such as being opaque, to a second condition, such as being transparent or translucent.

Various aspects of this invention will become apparent to those skilled in the art from the following detailed description of the preferred embodiments, when read in light of the accompanying drawings.

### BRIEF DESCRIPTION OF THE DRAWINGS

FIG. 1 is a top plan view of a first embodiment of a thermochromic device in accordance with this invention, wherein a layer of a thermochromic material is shown in an opaque condition.

FIG. 2 is a top plan view of the first embodiment of the thermochromic device illustrated in FIG. 1, wherein the layer of the thermochromic material is shown in a transparent condition.

FIG. 3 is a top plan view of a second embodiment of a thermochromic device in accordance with this invention, wherein an outermost layer of a thermochromic material is shown in an opaque condition.

FIG. 4 is a top plan view of the second embodiment of the thermochromic device illustrated in FIG. 3, wherein the outermost layer of the thermochromic material is shown in a transparent condition and an intermediate layer of the thermochromic material is shown in an opaque condition.

FIG. 5 is a top plan view of the second embodiment of the thermochromic device illustrated in FIG. 4, wherein the outermost and intermediate layers of the thermochromic material are shown in a transparent condition and an innermost layer of the thermochromic material is shown in an opaque condition.

FIG. 6 is a top plan view of the second embodiment of the thermochromic device illustrated in FIG. 5, wherein the outermost, intermediate, and innermost layers of the thermochromic material are shown in a transparent condition.

### DETAILED DESCRIPTION OF THE PREFERRED EMBODIMENTS

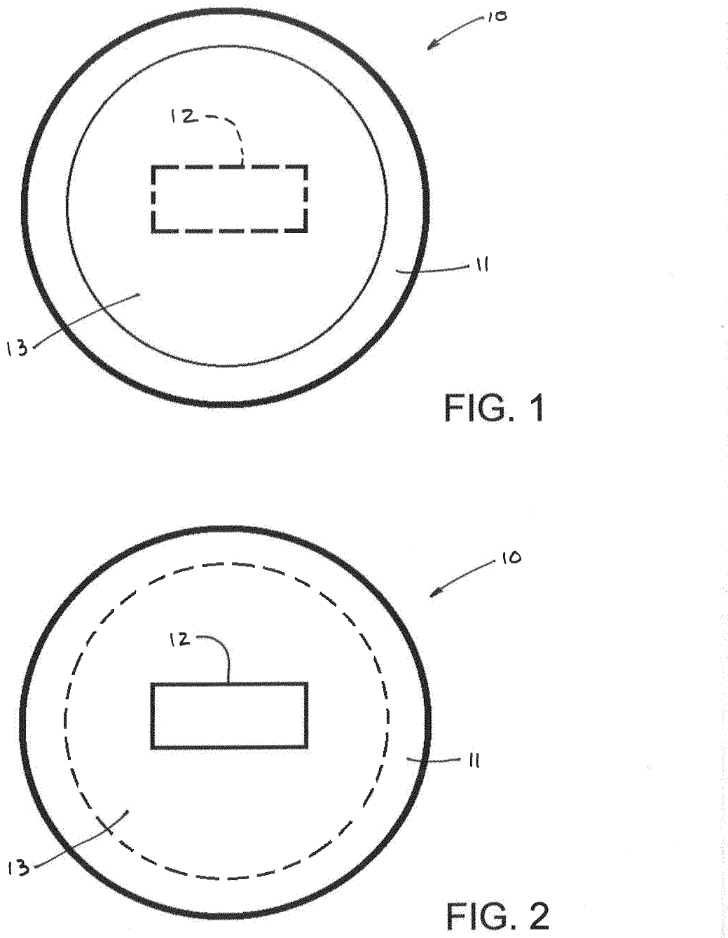

Referring now to the drawings, there is illustrated in FIGS. 1 and 2 a first embodiment of a thermochromic device, indicated generally at 10, in accordance with this invention. The illustrated first embodiment of the thermochromic device 10 includes a base 11 that is circular in shape. However, the base 11 of the first embodiment of the thermochromic device 10 may have any desired shape. The base 11 of the first embodiment of the thermochromic device 10 may be formed from any desired material or combination of materials and may have any desired thickness or combination of thicknesses.

The first embodiment of the thermochromic device 10 also includes an image 12 that is supported or otherwise provided on the base 11 thereof. The illustrated image 12 is rectangular in shape and is formed as a separate piece from the base 11. However, the image 12 of the first embodiment of the thermochromic device 10 may have any desired shape and may be formed integrally with the base 11. Additionally, a plurality of discrete images 12 may be provided on the base 11 of the first embodiment of the thermochromic device 10. The illustrated image 12 is secured to a surface of the base 11 of the first embodiment of the thermochromic device 10 by an adhesive (not shown). However, the image 12 may be secured to or otherwise retained on the base 11 of the first embodiment of the thermochromic device 10 in any desired manner. The image 12 of the first embodiment of the thermochromic device 10 may be formed from any desired material or combination of materials and may have any desired thickness or combination of thicknesses.

The first embodiment of the thermochromic device 10 further includes a layer 13 of a thermochromic material that is that is supported or otherwise provided on the base 11. The illustrated layer of thermochromic material 13 is provided as a single portion of material that is circular in shape. However, the layer of thermochromic material 13 may be provided as two or more discrete portions of material, and the portion or portions of the layer of thermochromic material 13 may have any desired shape or combination of shapes. The illustrated layer of thermochromic material 13 extends completely over the image 12 and over most of the surface of the base 11. However, the layer of thermochromic material 13 may extend over any desired portion or portions of either or both of the image 12 and/or the base 11.

The operation of the first embodiment of the thermochromic device 10 will now be described. Preferably, as shown in FIG. 1, the illustrated layer of thermochromic material 13 is opaque when at room temperature. Thus, the image 12 and the other portions of the surface of the base 11 covered by the illustrated layer of thermochromic material 13 cannot be seen. However, when the temperature of the illustrated layer of thermochromic material 13 is increased above (or otherwise changes across) a predetermined magnitude, the illustrated layer of thermochromic material 13 changes from a first condition (such as, for example, being opaque) to a second condition (such as, for example, being transparent or translucent), as shown in FIG. 2. Thus, the image 12 and the other portions of the base 11 covered by the previously opaque layer of thermochromic material 13 can be seen. Conversely, when the temperature of the illustrated layer of thermochromic material 13 is subsequently decreased below the predetermined magnitude, the illustrated layer of thermochromic material 13 changes back from being transparent or translucent to opaque, as shown in FIG. 1.

The predetermined magnitude of the temperature at which the layer of thermochromic material 13 changes from being opaque to transparent is preferably about 88° F. However, this predetermined magnitude of the temperature may be any desired temperature. Typically, this predetermined magnitude of the temperature may range from about 55° F. to about 113° F., although higher or lower temperatures may be used.

Alternatively, instead of changing between opaque and transparent (or translucent) properties, the visual characteristics of the layer of thermochromic material 13 may change in any other desired manner when the temperature thereof transitions from below the predetermined magnitude to above the predetermined magnitude, and/or vice versa. For example, the layer of thermochromic material 13 may change from one color, hue, tint, tone, or shade to another as a result of this transition. Preferably, however, the layer of thermochromic material 13 is either transparent or translucent when the temperature thereof is either above or below the predetermined magnitude, although such is not required. As a result, the image 12 is visible through the layer of thermochromic material 13 when the temperature thereof is either above or below the predetermined magnitude, or both. The reason for this will become apparent below in connection with a description of the many potential applications for this invention.

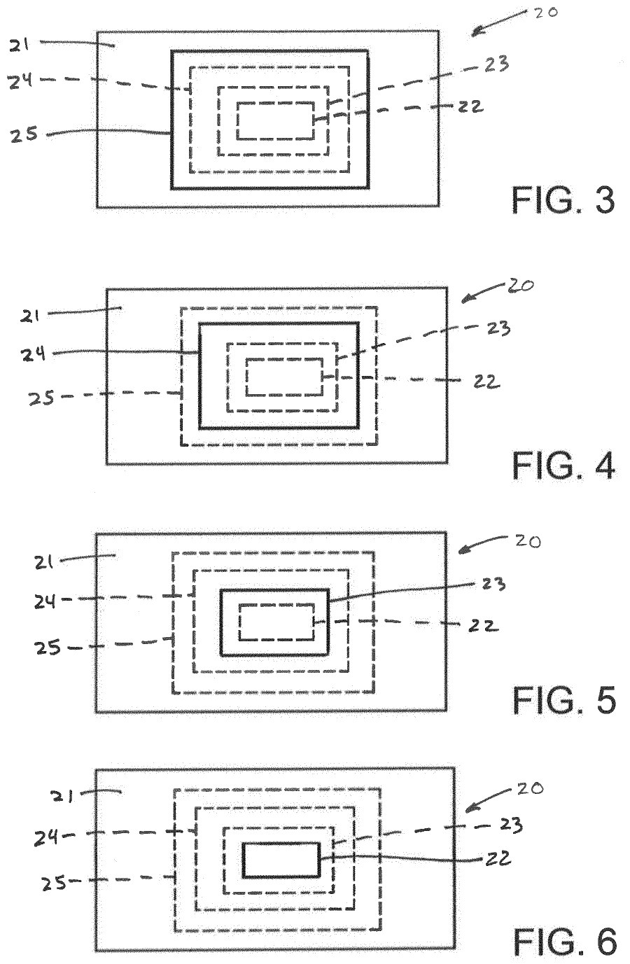

Referring now to FIGS. 3 through 6 of the drawings, there is illustrated a second embodiment of a thermochromic device, indicated generally at 20, in accordance with this invention. The illustrated second embodiment of the thermochromic device 20 includes a base 21 that is rectangular in shape. However, the base 21 of the second embodiment of the thermochromic device 20 may have any desired shape. The base 21 of the second embodiment of the thermochromic device 20 may be formed from any desired material or combination of materials and may have any desired thickness or combination of thicknesses.

The second embodiment of the thermochromic device 20 also includes an image 22 that is supported or otherwise provided on the base 21 thereof. The illustrated image 22 is rectangular in shape and is formed as a separate piece from the base 21. However, the image 22 of the second embodiment of the thermochromic device 20 may have any desired shape and may be formed integrally with the base 21. Additionally, a plurality of discrete images 22 may be provided on the base 21 of the second embodiment of the thermochromic device 10. The illustrated image 22 is secured to a surface of the base 21 of the second embodiment of the thermochromic device 20 by an adhesive (not shown). However, the image 22 may be secured to or otherwise retained on the base 21 of the second embodiment of the thermochromic device 20 in any desired manner. The image 22 of the second embodiment of the thermochromic device 20 may be formed from any desired material or combination of materials and may have any desired thickness or combination of thicknesses.

The second embodiment of the thermochromic device 20 further includes a first layer 23 of a thermochromic material that is supported or otherwise provided on the base 21. The illustrated first layer of thermochromic material 23 is provided as a single portion of material that is rectangular in shape. However, the first layer of thermochromic material 23 may be provided as two or more discrete portions of material, and the portion or portions of the first layer of thermochromic material 23 may have any desired shape or combination of shapes. The illustrated first layer of thermochromic material 23 extends completely over the image 22 and over a first portion of the surface of the base 21. However, the first layer of thermochromic material 23 may extend over any desired portion or portions of either or both of the image 22 and/or the base 21.

Additionally, the second embodiment of the thermochromic device 20 includes a second layer 24 of a thermochromic material that is supported or otherwise provided on the first layer of thermochromic material 23 and the base 21. The illustrated second layer of thermochromic material 24 is provided as a single portion of material that is rectangular in shape. However, the second layer of thermochromic material 24 may be provided as two or more discrete portions of material, and the portion or portions of the second layer of thermochromic material 24 may have any desired shape or combination of shapes. The illustrated second layer of thermochromic material 24 extends completely over the first layer of thermochromic material 23 and over a second portion of the surface of the base 21. However, the second layer of thermochromic material 24 may extend over any desired portion or portions of some or all of the first layer of thermochromic material 23, the image 22, and/or the base 21.

Lastly, the second embodiment of the thermochromic device 20 includes a third layer 25 of a thermochromic material that is that is supported or otherwise provided on the second layer of thermochromic material 24 and the base 21. The illustrated third layer of thermochromic material 25 is provided as a single portion of material that is rectangular in shape. However, the third layer of thermochromic material 25 may be provided as two or more discrete portions of material, and the portion or portions of the third layer of thermochromic material 25 may have any desired shape or combination of shapes. The illustrated third layer of thermochromic material 25 extends completely over the second layer of thermochromic material 24 and over a third portion of the surface of the base 21. However, the third layer of thermochromic material 25 may extend over any desired portion or portions of some or all of the second layer of thermochromic material 24, the first layer of thermochromic material 23, the image 22, and/or the base 21.

The operation of the second embodiment of the thermochromic device 10 will now be described. Initially, as shown in FIG. 3, the illustrated third (outermost) layer of thermochromic material 25 is opaque when at room temperature. Thus, the second (intermediate) layer of thermochromic material 24, the first (innermost) layer of thermochromic material 23, the image 22, and the other portions of the surface of the base 21 covered by the illustrated third layer of thermochromic material 25 cannot be seen. However, when the temperature of the illustrated third layer of thermochromic material 25 is increased above a first predetermined magnitude (such as, for example, 68° F.), the illustrated third layer of thermochromic material 25 changes from being opaque to transparent (or at least translucent), as shown in FIG. 4. Similarly, when the temperature of the illustrated third layer of thermochromic material 25 is subsequently decreased below the first predetermined magnitude, the illustrated third layer of thermochromic material 25 changes back from being transparent or translucent to opaque, as shown in FIG. 3.

When the temperature of the illustrated second layer of thermochromic material 24 is above the first predetermined magnitude but below a second predetermined magnitude (such as, for example, 78° F.), the illustrated second layer of thermochromic material 24 is opaque, as shown in FIG. 4. Thus, the first layer of thermochromic material 23, the image 22, and the other portions of the surface of the base 21 covered by the illustrated second layer of thermochromic material 24 cannot be seen. However, when the temperature of the illustrated second layer of thermochromic material 24 is increased above the second predetermined magnitude, the illustrated second layer of thermochromic material 24 changes from being opaque to transparent (or at least translucent), as shown in FIG. 5. Similarly, when the temperature of the illustrated second layer of thermochromic material 24 is subsequently decreased below the second predetermined magnitude, the illustrated second layer of thermochromic material 24 changes back from being transparent or translucent to opaque, as shown in FIG. 4.

Lastly, when the temperature of the illustrated first layer of thermochromic material 23 is above the second predetermined magnitude but below a third predetermined magnitude (such as, for example, 88° F.), the illustrated first layer of thermochromic material 23 is opaque, as shown in FIG. 5. Thus, the image 22 and the other portions of the surface of the base 21 covered by the illustrated first layer of thermochromic material 23 cannot be seen. However, when the temperature of the illustrated first layer of thermochromic material 23 is increased above the third predetermined magnitude, the illustrated first layer of thermochromic material 23 changes from being opaque to transparent (or at least translucent), as shown in FIG. 6. Similarly, when the temperature of the illustrated first layer of thermochromic material 23 is subsequently decreased below the third predetermined magnitude, the illustrated first layer of thermochromic material 23 changes back from being transparent or translucent to opaque, as shown in FIG. 5.

Alternatively, instead of changing between opaque and transparent (or translucent) properties, the visual characteristics of any one or more of the layers of thermochromic material 23, 24, and 25 may change in any other desired manner when the temperature thereof transitions from below the associated predetermined magnitude to above the associated predetermined magnitude, and vice versa. For example, any one or more of the layers of thermochromic material 23, 24, and 25 may change from one color, hue, tint, tone, or shade to another. Preferably, each of the layers of thermochromic material 23, 24, and 25 is either transparent or translucent when the temperature thereof is either above or below the associated predetermined magnitude, although such is not required. As a result, the image 22 is visible through the layers of thermochromic material 23, 24, and 25 when the temperature thereof is either above or below the associated predetermined magnitudes. The reason for this will become apparent below in connection with a description of the many potential applications for this invention.

This invention contemplates that either or both of the thermochromic devices 10 and 20 may be used in a large number of environments (such as sinks and urinals, for example) for a variety of purposes (such as encouraging desirable behaviors and entertainment, for example). The environments and purposes discussed below are intended to be illustrative of only some aspects of this invention and are not intended to limit the scope thereof.

One environment in which the thermochromic device 10 or 20 may be used is within a sink or other water basin to train a child how to properly wash his/her hands or to brush his/her teeth. An effective device for this purpose would be a thermochromic device that is placed in the sink or other water basin that changes color when the temperature of the water reaches a predetermined temperature level. For example, when the water reaches the predetermined temperature level of 88° F. or higher, the thermochromic device 10 or 20 would change color to indicate to the user that his/her hands have been under running water for at least a predetermined amount of time (such as, for example, twenty seconds). In a preferred embodiment, a chromatographic opaque ink/paint is applied directly to the underside of the top layer of a laminated decal. The thermochromic opaque ink/paint is designed to become transparent when reaching the predetermined temperature level (such as 88° F., for example) to reveal an image below the chromatographic opaque ink/paint layer. The image could be an amusing image, such as a cartoon character and/or an advertisement. This will encourage children to keep their hands under the running water of the sink until they see the amusing image appear on the thermochromic device 10 or 20 placed in the bottom of the sink or other water basin.

The thermochromic device 10 or 20 can also be installed within the sink or water basin as a training device for maintaining a child's attention while washing his/her hands or brushing his/her teeth. In this instance, the amusement and entertainment provided by the thermochromic device 10 or 20 will encourage a child to wash their hands and brush their teeth for a longer period of time.

Alternatively, the thermochromic device 10 or 20 may be placed within a urinal to help a user aim and direct a flow of urine in a direction that reduces the amount of urine that ends up on the bathroom floor, thereby promoting sanitation. Such a thermochromic device 10 or 20 installed in a urinal can helps to direct urine flow in a certain direction that will help to keep the urine within the urinal, while reducing the amount of urine that ends up on the bathroom floor. The thermochromic device 10 or 20 may include either an image that changes color or a covering layer over the image that changes from color (opaque) to clear (transparent), in response to temperature, as described above. The thermochromic device 10 or 20 can be either permanently fixed to or removable from the urinal. For example, the thermochromic device may be either fixed on a pad or strainer disposed within the urinal, permanently embedded in a material of an object (such as, for example, located inside of a urine strainer found covering holes in the urinal), or removable and placed on an object (or fixed to an object, wall, etc.) by a holder, tape, or adhesive backing. In one embodiment, the image may be formed of a thermochromic crystal, paint, tape, or other material that is placed in one or more areas within a urinal to help a user direct the flow of urine at the images inside of the urinal, so that less urine will be directed to the floor. The image may be an advertisement, entertaining image, or other ornamental design. The device may incorporate more than one thermochromic composition to thereby allow one or more images to change colors at more than just one predetermined temperature.

Thermochromic coloring can be achieved using crystals, powder, tape, paint, pigments, or ink, or a combination of these components. The thermochromic device 10 or 20 may incorporate more than one thermochromic composition so that the top surface and/or images on the device change colors at more than just one temperature. The thermochromic device 10 or 20 can also be provided in the form of a decal/picture that will stick to the surface within a urinal, sink or wash basin. The thermochromic device 10 or 20 may be made to be placed within a holder. For instance, the decal or picture containing the thermochromic materials can be placed within a holder or other device that is affixed within a sink, urinal, or other wash basin. The picture or decal of the thermochromic device 10 or 20 may be made out of regular, currently used ink and covered by a form of thermochromic coloring. Alternatively, the decal or picture can be made of thermochromic coloring. The decal or picture can be textured to better hold the thermochromic covering crystal, powder, paint, ink, pigment or a combination thereof. The decal/picture can be made with or without advertising. Moreover, the picture or decal can be the actual advertising. The thermochromic device may include an adhesive on the back of the decal/picture that will allow the device to stick to porcelain, glass, plastic and other material surfaces. The decal/picture may contain a protective covering, tape, plastic, rubber, or paint. The chromatographic opaque ink/paint may be applied directly to the underside of the top material layer before covering the object to be revealed. This process will enable cross functionality for many uses to laminate a label with a revealable covering.

In summary, the thermochromic device 10 or 20 of this invention may provide an aiming device for placement in a urinal that changes color at a predetermined temperature, such as, for example, 88° F. Such a thermochromic device 10 or 20 may also provide an aiming device for placement in a urinal to help direct urine flow in a direction that discourages urine from ending up on the bathroom floor. The thermochromic device 10 or 20 may also provide an aiming device in the form of a picture or decal that will stick on a surface in a sink, urinal, or other water basin, or on a pad affixed to the sink, urinal, or other water basin. Also, the thermochromic device 10 or 20 also provides an aiming device for placement within urinals that changes color at certain temperatures and returns back to the original color when the image on the device cools back to room temperature. In the second embodiment described above, the thermochromic device 20 can change color at more than one predetermined temperature.

It is an object of this invention to provide an aiming device for placement within sinks, urinals, and other water basins that includes thermochromic crystals, thermochromic tape, powder, liquid, ink, paint, pigment, and/or a mixture with thermochromic crystals, powder, liquid, ink, paint, pigment, or any combination. It is another object of this invention to provide an aiming device for placement within sinks, urinals, and other water basins that includes a thermochromic material that can be placed or embedded in a material such as, for example, a urinal pad or strainer. It is a further object of this invention to provide an aiming device for placement within sinks, urinals, and other water basins wherein the thickness of a thermochromic material may vary along with the thickness of the base pure material (for example, the thickness of rubber or other material within which the thermochromic crystals are contained), and further wherein the concentration of thermochromic material may vary.

Other object of this invention include providing an aiming device for placement within urinals that (1) includes one or more images that can be an advertisement, entertainment image, and/or an ornamental image, (2) may or may not be bio-friendly, (3) contains a thermochromic material that changes color in response to temperature changes, wherein the thermochromic material is nontoxic, and (4) contains one or more images that change color in response to temperature changes, wherein the coloring on the top surface changes from opaque to clear to expose the images below (such as, for example, a black cover changing to clear). Urinal objects placed inside a urinal may be made of a base with thermochromic material so when urine flow is directed on the object, it turns color or from color (opaque) to transparent due to the temperature of the urine. This will help the user to focus the urine flow direct to the object and keep the stream in the urinal so less urine is directed to the floor.

This invention also contemplates that a chromatographic layer may cover a label that is laminated (or alternatively formed from a vinyl or other material) with or without adhesive for the purpose of placing in a sink, urinal, or other water basin. The objective is that turning on the warm water will encourage a user to wash his/her hands for at least twenty seconds while waiting for the picture under the chromatographic layer to be revealed. Alternatively, the chromatographic ink/paint may be laminated, with or without adhesive, and placed over any object (such as a key, paper clip, coin, flat toy, and the like) in a sink, urinal, or other water basin such that when warm water or heat is applied, the object is revealed. The top layer of material may require preparing (i.e., roughing, pitting, heating or other treatment) to accept the ink/paint, which may be impregnated and/or otherwise incorporated into a mixture of the upper layer, with the chromatographic ink/paint.

The principle and mode of operation of this invention have been explained and illustrated in its preferred embodiments. However, it must be understood that this invention may be practiced otherwise than as specifically explained and illustrated without departing from its spirit or scope.

What is claimed is:

1. A thermochromic device comprising:
a base including a surface;
an image provided on the surface of the base; and
a layer of thermochromic material that covers at least a portion of the image provided on the surface of the base, wherein when a temperature of the layer of thermochromic material changes across a predetermined magnitude, a visual characteristic of the layer of thermochromic material changes from a first condition to a second condition.

2. The thermochromic device defined in claim 1 wherein the layer of thermochromic material covers all of the image provided on the surface of the base.

3. The thermochromic device defined in claim 1 wherein the layer of thermochromic material also covers at least a portion of the surface of the base.

4. The thermochromic device defined in claim 1 wherein when the temperature of the layer of thermochromic material increases above the predetermined magnitude, the visual characteristic of the layer of thermochromic material changes from the first condition to the second condition.

5. A thermochromic device comprising:
a base including a surface;
an image provided on the surface of the base;
a first layer of thermochromic material that covers at least a portion of the image provided on the surface of the base, wherein when a temperature of the first layer of thermochromic material changes across a first predetermined magnitude, a visual characteristic of the first layer of thermochromic material changes from a first condition to a second condition; and
a second layer of thermochromic material that covers at least a portion of the first layer of thermochromic material and the image, wherein when a temperature of the second layer of thermochromic material changes across a second predetermined magnitude different from the first predetermined magnitude, a visual characteristic of the second layer of thermochromic material changes from a first condition to a second condition.

6. The thermochromic device defined in claim 5 wherein the first layer of thermochromic material covers all of the image provided on the surface of the base.

7. The thermochromic device defined in claim 5 wherein the first layer of thermochromic material also covers at least a portion of the surface of the base.

8. The thermochromic device defined in claim 5 wherein when the temperature of the first layer of thermochromic material increases above the first predetermined magnitude, the visual characteristic of the first layer of thermochromic material changes from the first condition to the second condition.

9. The thermochromic device defined in claim 7 wherein the second predetermined magnitude is greater than the first predetermined magnitude.

10. The thermochromic device defined in claim 9 wherein when the temperature of the second layer of thermochromic material increases above the second predetermined magnitude, the visual characteristic of the second layer of thermochromic material changes from the first condition to the second condition.

11. The thermochromic device defined in claim 5 further including a third layer of thermochromic material that covers at least a portion of the second layer of thermochromic material, the first layer, of thermochromic material and the image, wherein when a temperature of the third layer of thermochromic material changes across a third predetermined magnitude different from both the second predetermined magnitude and the first predetermined magnitude, a visual characteristic of the third layer of thermochromic material changes from a first condition to a second condition.

12. The thermochromic device defined in claim 11 wherein the first layer of thermochromic material covers all of the image provided on the surface of the base.

13. The thermochromic device defined in claim 11 wherein the first layer of thermochromic material also covers at least a portion of the surface of the base.

14. The thermochromic device defined in claim 11 wherein when the temperature of the third layer of thermochromic material increases above the third predetermined magnitude, the visual characteristic of the third layer of thermochromic material changes from the first condition to the second condition.

15. The thermochromic device defined in claim 14 wherein the third predetermined magnitude is greater than the second predetermined magnitude, and the second predetermined magnitude is greater than the first predetermined magnitude.
